(19) United States
(12) Patent Application Publication
(10) Pub. No.: US 2017/0218138 A1
(43) Pub. Date: Aug. 3, 2017

(54) METHOD FOR PREPARING POLYMER THIN FILM BY GAS-LIQUID INTERFACE PLASMA POLYMERIZATION AND POLYMER THIN FILM PREPARED BY THE SAME

(71) Applicant: The Industry & Academic Cooperation in Chungnam National University (IAC), Daejeon (KR)

(72) Inventors: Ho-Suk Choi, Daejeon (KR); Quoc Chinh Tran, Daejeon (KR)

(73) Assignee: The Industry & Academic Cooperation in Chungnam National University (IAC)

(21) Appl. No.: 15/486,959

(22) Filed: Apr. 13, 2017

Related U.S. Application Data
(63) Continuation of application No. PCT/KR2015/004309, filed on Apr. 29, 2015.

(30) Foreign Application Priority Data
Oct. 29, 2014 (KR) 10-2014-0148118

(51) Int. Cl. C08J 3/28; H01M 10/0565; C08J 5/22

(52) U.S. Cl. CPC C08J 3/28; C08J 5/2256; H01M 10/0565; C08J 2371/02; H01M 2300/0082; H01M 2300/0085

(57) ABSTRACT

The present invention relates to a method for preparing a plasma polymer thin film excellent in thermal properties and thus suitable for the matrix of a gel polymer electrolyte, a plasma polymer thin film prepared by the method, and a gel polymer electrolyte and a secondary cell using the plasma polymer thin film. More specifically, the present invention relates to a method for preparing a polymer thin film by plasma polymerization in which plasma is applied to an interface of a liquid-state monomer to perform polymerization, a polymer thin film prepared by the method, and a gel polymer electrolyte and a secondary cell using the polymer thin film.

### CROSS-REFERENCE TO RELATED APPLICATION

This is a continuation of International Application No. PCT/KR2015/004309, with an international filing date of Apr. 29, 2015, which claims the benefit of Korean Application No. 10-2014-0148118 filed on Oct. 29, 2014, the entire contents of which applications are incorporated herein by reference.

### TECHNICAL FIELD

The present invention relates to a method for preparing a plasma polymer thin film excellent in thermal properties and thus suitable for the matrix of a gel polymer electrolyte, a plasma polymer thin film prepared by the method, and a gel polymer electrolyte and a secondary cell using the plasma polymer thin film.

### BACKGROUND ART

With the demands for the smaller and lighter electronic equipment in addition to the extension of electric, electronic, communication, computer, and electric automobile industries, there have been actively made researches on the electrochemical devices with high energy density used as an energy source related to the technologies. A secondary cell, a representative example of the electrochemical devices capable of realizing high energy density, is a device that converts external electric energy to chemical energy, stores the chemical energy and changes it to electric energy whenever necessary. The secondary cell offers economical and environmental benefits, as it can be recharged many times and reusable, while a primary battery is designed to be used once and discarded. Examples of the secondary cell include lead-acid accumulator, nickel-cadmium battery, nickel-metal hydride battery, lithium-ion battery, etc.

The secondary cell consists of a separator that keeps cathode and anode apart to prevent an electrical short circuit occurring due to the cathode-anode physical contact, and an electrolyte that plays an actual role in the movement of ions between cathode and anode. The electrolyte for the secondary cell is usually a liquid-state electrolyte prepared by dissolving salts in a non-aqueous organic solvent. Interest picks up in the polymer electrolytes, as a question is raised on the safety of the liquid-state electrolyte concerning the risk of explosion due to the volatilization and leakage of organic solvents and the degradation of electrode materials.

The polymer electrolytes are classified into solid-state polymer electrolyte and gel polymer electrolyte. As for the solid-state polymer electrolyte, the ions of salts added to a polymer having polar groups move in the polymer to cause ionic conduction. So, the solid-state polymer electrolyte requires no special structure for prevention of leakage, displays good processability in the form of a film and offers easiness in the fabrication of cells. But, the solid-state polymer electrolyte has been developed only for limited applications, such as high-temperature operated or thin film type cells, due to its lower ion conductivity than the liquid-state electrolyte.

The gel polymer electrolyte consists of a carbonate-based non-aqueous organic solvent, a salt, and an organic solvent (or a plasticizer) having high ion conductivity and high boiling temperature that are impregnated into a polymer matrix to cause ionic conduction. Generally, the organic solvent acts to induce ionic conduction and the polymer functions as a support for the electrolyte. Examples of the polymer matrix for the gel polymer electrolyte may include polyethylene oxide (PEO), polyacrylonitrile (PAN), polymethylmethacrylate (PMMA), and polyvinylidene fluoride (PVdF). The PEO-based polymer electrolyte has an ion conductivity of about 10⁻⁸ S/cm at room temperature and at least 10⁻⁵ S/cm only at the melting temperature or above. Particularly, the PEO-based polymer electrolyte has poor durability at low temperature due to its low glass transition temperature and low melting temperature, so it needs to improve in regards to the melting temperature or chemical resistance. The PAN- and PVdF-based gel polymer electrolyte is an electrolyte with cross-linking and inclined to break in structure over time.

Unlike the general polymer polymerization, the plasma polymerization can be used to create a uniform thin film without defects, even though the film is an ultra-thin film having a thickness of 0.01 μm and to polymerize monomers having no reactive group, so it offers a wide choice of monomers. The polymers created by the plasma polymerization mostly has a compact structure with high degree of cross-linking, which contributes to the excellences of the polymers in terms of chemical resistance, thermal resistance and mechanical properties. Therefore, the polymers produced by the plasma polymerization are expected to possess characteristics suited as a matrix for the gel polymer electrolyte. The plasma polymerization needs to be performed under vacuum and thus ends up with high cost in the polymer production and difficulty in the fabrication or large-scaled production of large-area polymer thin films.

### SUMMARY

To solve the problems with the prior art, it is an object of the present invention to provide a method for preparing a plasma polymer thin film having characteristics suited as a polymer matrix for gel polymer electrolyte under conditions of normal temperature and pressure, and a plasma polymer thin film prepared by the method.

It is another object of the present invention to provide a polymer matrix for gel polymer electrolyte that comprises the plasma polymer thin film and displays high durability.

It is still another object of the present invention to provide a gel polymer electrolyte using the polymer matrix and having high ion conductivity and a secondary cell comprising the gel polymer electrolyte.

To achieve the objects of the present invention, there is provided a method for preparing a polymer thin film by plasma polymerization that includes applying plasma to an interface of a liquid-state monomer to perform polymerization.

The conventional plasma polymerization involves converting a gaseous monomer into plasma under vacuum and performing polymerization, and the polymers thus produced are processed in the form of a film applied on a substrate by coating. Alternatively, the conventional plasma polymerization includes forming plasma in a monomer solution to induce a liquid-state plasma reaction to produce polymers. In contrast, the present invention involves forming plasma in the interface of the liquid-state monomer to cause polymerization in the gas-liquid interface, forming polymers in the form of a film from the surface of the solution. With a plasma electrode positioned 0.1 to 5 mm above the interface of the liquid-state monomer, an application of voltage to the electrode causes formation of plasma in the interface of the liquid-state monomer. Positioning the plasma electrode too far to the interface of the liquid-state monomer results in a sharp drop of the energy transferred to the interface to make the formation of plasma inefficient. With the plasma electrode too close from the interface of the liquid-state monomer, the energy is transferred to the whole solution rather than the interface, which leads to inefficiency in the interface polymerization.

The liquid-state monomer may undergo a polymerization reaction while it is put in a container or its coating is applied on a substrate for the sake of having the wider surface. In other words, the method for preparing a polymer thin film by plasma polymerization may include: (A) applying the liquid-state monomer on the substrate by coating; (B) applying plasma to an interface of the coating of the monomer to cause polymerization; and (C) exfoliating a plasma-polymerized polymer from the substrate.

The shape of the polymer thin film to be formed depends on the substrate. When the substrate is flat, the polymers produced are formed into a flat thin film. With the curved substrate, a curved thin film is made. Further, a substrate with an uneven pattern results in forming a thin film with an uneven pattern. The substrate is a glass substrate in the following example. But the material of the substrate is not specifically limited because the substrate is used just to maintain the shape of the thin film by applying a coating of the monomer solution prior to the polymerization. In other words, the substrate may be made of a metal (e.g., aluminum or steel) or a polymer resin (e.g., polyethylene or polydimethylsiloxane (PDMS)).

Applying a coating of the liquid-state monomer on the substrate may be carried out using any coating method that is available to apply a coating of a liquid. Namely, examples of the coating method as used herein may include, but are not limited to, spin coating, bar coating, screen coating, inkjet coating, dip coating, or spray coating.

The polymer thus produced is exfoliated from the substrate and obtained in the form of a thin film. The exfoliation of the polymer may include physically removing the polymer from the substrate or immersing the substrate in a solvent and separating a thin film from the substrate. Examples of the solvent as used herein may include, but are not limited to, organic solvents, such as acetone, ethanol, methanol, hexane, dimethylacetylamide (DMAC), etc.

The liquid-state monomer is preferably a mixture of an ionic liquid and polyethylene oxide.

The term “ionic liquid” as used herein refers to an ionic salt present in the liquid state at 100° C. or below. Generally, an ionic salt compound consisting of a metallic cation and a nonmetallic anion melts at high temperature of 800° C. or above. Unlike the ionic salt compound, the ionic liquid is present in the liquid state at low temperature of 100° C. or below. The typical examples of room-temperature ionic liquid may include imidazole-based compounds or pyrrolidium-based compounds. As for these compounds, their derivatives in which at least one carbon chain substituted for N contains three (C3) or more carbon atoms are known to have the properties of an ionic liquid. In the example of the present invention, the ionic liquid is BMIM (1-butyl-3-methylimidazolium) or BMMIM (1-butyl-2,3-dimethylimidazolium) salt. But, examples of the ionic liquid are not limited to those mentioned above. According to a prior experiment, the ionic liquids which are salts consisting of a cation being substituted or unsubstituted 1-R-1-methylpyrrolidium or substituted or unsubstituted 1-R-3-methylimidazolium, where R is C3-C16 alkyl, and an anion being BF₄⁻, F⁻, Cl⁻, Br⁻, or I⁻ can form plasma polymers like the BMIM salt to realize the structural and electrical properties similar to those of the plasma polymers produced using the BMIM salt. The ionic liquids where R is methyl or ethyl do no have properties characteristic to the ionic liquid. When using the ionic liquid where R is at least C17 alkyl, the resultant plasma polymer displays poor ion conductivity.

Polyethylene oxide is a polymer of the monomer having an ethylene oxide group and has a repeating unit of —(CH₂CH₂O)ₙ—. Any type of polyethylene oxide is available as long as it has a molecular weight between 200 and 2,000 and is miscible with the ionic liquid. The polyethylene oxide with extremely large molecular weight displays the properties of hard wax and thus has difficulty in forming a homogeneous mixture with the ionic liquid. In the following example, the polyethylene oxide is Triton X or Tween series polyethylene oxide. As the C═O bonds are produced in the plasma polymer and the repeating unit of ethylene oxide (—(CH₂CH₂O)ₙ—) participates in the polymerization reaction, it is the obvious fact that the compounds having a different structure of the side chain may also form a plasma polymer according to the method of the present invention. Hence, the polyethylene oxide as used herein is not specifically limited to those listed above. Triton X-100 and Triton X-200 are given as examples of the Triton X series polyethylene oxide in the present invention. But, a prior experiment shows that other Triton X series compounds having a different repeating unit of ethylene oxide can also form a polymer. In addition, Tween 20 and Tween 60 that have a different ester chain can also form a polymer having the same aspects as those produced using Tween 80. The plasma polymer of the present invention may also be formed using other types of polyethylene oxide, including POE alkyl phenyl ether (e.g., POE nonyl phenyl ether or POE tristyrenated phenyl ether) rather than Triton series, and POE alkyl ether (e.g., POE lauryl ether, POE stearyl ether, POE oleyl ether, or POE tridecyl ether) or POE alkyl amine (e.g., POE lauryl amine, POE oleyl amine, or POE stearyl amine) rather than Tween series.

The mixing ratio of the ionic liquid to the polyethylene oxide varies depending on the types of the ionic liquid and the polyethylene oxide, so fixing the value of the mixing ratio is of no use. It may be easy for those skilled in the art to determine the optimal mixing ratio according to the repeated experiments. But, the content of the Triton X or Tween 80 series polyethylene oxide is preferably 25 mol. % or less with respect to the total weight of the mixture solution. An extremely high content of the polyethylene oxide leads to the reduced speed of film formation and the greater proportion of single bonds in the film, causing deterioration in the ion conductivity.

Plasma is applied to the coated mixture to perform polymerization. The application of plasma is carried out at room temperature to activate polymerization. Applying plasma under vacuum is not excluded. It is apparent that the conditions of the plasma reaction can be properly controlled as a function of the reactants. Further, the thickness of the plasma polymer produced can be controlled by adjusting the intensity of the plasma or the reaction time. The reaction time and the intensity of the plasma are proportional to the thickness of the plasma polymer produced.

The present invention is also directed to a plasma polymer prepared by the above-described method. The plasma polymer according to the present invention displays good thermal properties and good chemical resistance to organic solvents.

The present invention is also directed to a polymer matrix for gel polymer electrolyte that comprises the plasma polymer. Due to its excellences in thermal and chemical resistance and mechanical strengths, the plasma polymer enables the polymer matrix alone to act as a separator or a support and eliminates the need for a special separator or support.

The present invention is also directed to a gel polymer electrolyte in which an organic electrolyte containing an ionic salt is impregnated in the plasma polymer of the present invention. The ionic salt contained in the organic electrolyte may be an ionic salt such as lithium salt dissolved in a carbonate-based organic solvent or an ionic liquid in which a salt acts as an organic electrolyte. The gel polymer electrolyte of the present invention is characterized by a polymer matrix into which the organic electrolyte is impregnated. Specific examples of the ionic salt, organic solvent or ionic liquid may be appropriately selected by those skilled in the art and will be omitted in this specification. The gel polymer electrolyte of the present invention displays high ion conductivity of about 10⁻³ at room temperature even through it is several micrometers thick, and thus can be used in the fabrication of ultra-thin secondary cells.

The present invention also provides a secondary cell comprising the gel polymer electrolyte.

As described above, the method for preparing a plasma polymer according to the present invention enables the preparation of a plasma polymer having properties suited to a polymer matrix for gel polymer electrolyte by way of an environment-friendly method that is fast and simple, under mild conditions of room temperature and pressure.

The polymer matrix for gel polymer electrolyte using the plasma polymer prepared by the method of the present invention is thermally, chemically and mechanically stable to realize good durability and capable of constructing a gel polymer electrolyte without a separate support.

Furthermore, the gel polymer electrolyte of the present invention is excellent in ion conductivity even at a thickness of several micrometers and thus can be used in the fabrication of ultrathin secondary cells.

### BRIEF DESCRIPTIONS OF DRAWINGS

FIG. 1 is a picture showing a polymer thin film being formed over time in accordance with one embodiment of the present invention.

FIG. 2 shows SEM images of the cross-section of the polymer thin film produced according to the reaction time in one embodiment of the present invention and a graph plotting the thickness of the thin film as a function of the reaction time.

FIG. 3 shows an SEM image of the cross-section of the polymer thin film produced according to the proportion of Triton X-100 in one embodiment of the present invention and a graph plotting the thickness of the thin film as a function of the proportion of Triton X-100.

FIG. 4 is an enlarged graph plotting the thickness of the thin film as a function of the proportion of Triton X-100 in a region having a low content of Triton X-100.

FIG. 5 shows (a)¹³C MAS-NMR, (b)¹H-MAS-NMR (at 15 kHz) and (c) FTIR spectra of the polymer thin film according to one embodiment of the present invention.

FIG. 6 shows an IR spectrum of the polymer thin film as a function of the content (mol. %) of Triton X-100 according to one embodiment of the present invention.

FIG. 7 shows an XPS spectrum of the polymer thin film according to one embodiment of the present invention and a graph plotting the ratio of elements in the polymer thin film as calculated from the XPS spectrum.

FIG. 8 shows spectra enlarging peaks corresponding to the is electrons of C and F as a function of the content (mol. %) of Triton X-100 in the polymer thin film according to one embodiment of the present invention.

FIG. 9 shows a spectrum presenting the simulation results of C1s peaks of FIG. 8.

FIG. 10 shows DSC and TGA spectra of the polymer thin film according to one embodiment of the present invention.

FIG. 11 is a graph plotting the impedance of a pouch cell prepared using the polymer thin film according to one embodiment of the present invention.

FIG. 12 is a graph plotting the ion conductivity of the polymer thin film calculated from the impedance of the pouch cell of FIG. 11.

### DETAILED DESCRIPTION

Reference will now be made in detail to the accompanying drawings, prior experiments and embodiments of the present invention. It will be understood that the accompanying drawings and embodiments are provided to give the better understanding on the contents and scope of the technical conceptions of the present invention and not to limit or change the technical scope of the present invention. It is apparent to those skilled in the art that various modifications and changes may be covered within the scope of the technical conceptions of the present invention based on the examples of the present invention.

### Example 1: Preparation of Plasma Polymer Thin Film

(1) Preparation of Plasma Polymer Thin Film from Polyethylene Oxide and Ionic Substance

Triton X-100 (Sigma-Aldrich, USA) was added to [BMIM]BF₄ (1-butyl-3-methylimidazolium tetrafluoroborate, Sigma-Aldrich) to reach the final Triton X-100 concentration of 6 mol. %, and the mixture was agitated with a vortex mixer (Vortex Mixer-KMC-1300V) for 5 minutes. 0.5 ml of the resultant solution was spin-coated on a 20×20 mm glass plate at 500 rpm for 15 seconds using a spin-coater (SPIN-1200D, MIDAS). Subsequently, a room-pressure plasma system (Ar, 150 W, 3 lpm) was used to perform polymerization for 10 minutes. The distance between the plasma electrode and the spin-coated thin film was 2 mm. The plasma-treated glass plate was immersed in ethanol to separate the thin film from it, and the thin film was washed with acetone and distilled water in sequence and dried out at 60° C. for one hour.

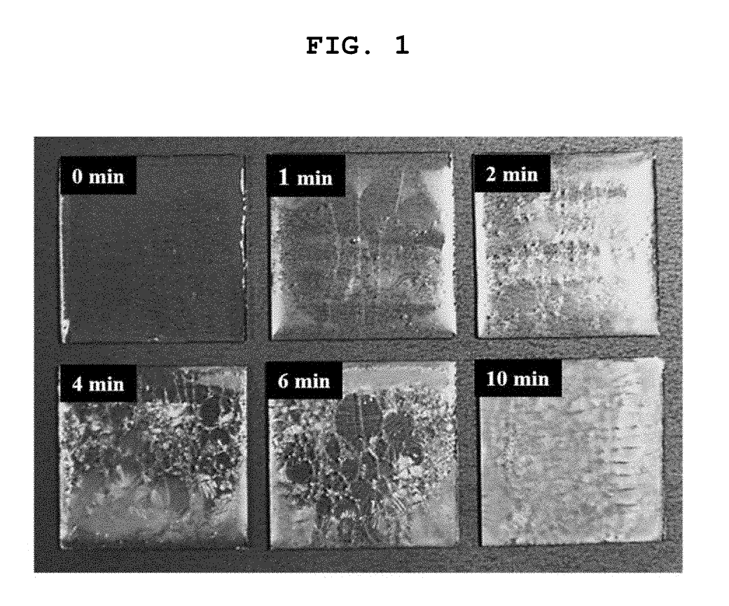

FIG. 1 is a picture showing a polymer thin film being formed over time. A visual observation shows that the thicker opaque thin film is created as the plasma application time increases.

Table 1 presents the results of the plasma polymerization under the above-specified conditions using different types of ionic substances and polyethylene oxide. In Table 1, [BMIM]BF₄ is 1-butyl-2,3-dimethylimidazolium tetrafluoroborate, and EMPyrr BF₄ is 1-ethyl-1-methylpyrrolidinium tetrafluoroborate.

TABLE 1

| | | Triton X- | Triton X- | |
|---|---|---|---|---|
| | Terpineol | 100 | 200 | Tween 20 |
| [BMIM]BF₄ | No rxn | Film formed | Film formed | Film formed |
| [BMIM]Cl | No rxn | Film formed | Film formed | Film formed |
| [BMIM]TFSI | No rxn | No rxn | No rxn | No rxn |
| [BMIM]Br | No rxn | Film formed | Film formed | Film formed |
| [BMIM]BF₄ | No rxn | Film formed | Film formed | Film formed |
| EMPyrr BF₄ | No rxn | No rxn | No rxn | No rxn |
| HCl | No rxn | Polymerized | Polymerized | Polymerized |
| HAuCl₄ | No rxn | Polymerized | Polymerized | Polymerized |
| Triton X- | No rxn | No rxn | No rxn | No rxn |
| 100 | | | | |

As can be seen from Table 1, terpineol other than polyethylene oxide did not participate in the polymerization reaction irrespective to the type of the ionic substance. And no polymerization reaction occurred irrespective to the type of the polyethylene oxide when the ionic substance was not added. EMPyrr BF₄, which is an inorganic salt other than an ionic substance did not participate in the polymerization reaction, either. When the ionic substance was an inorganic acid HCl or an inorganic salt HAuCl₄, a polymer was formed by the polymerization reaction but obtained in the form of powder or cake rather than a film. In contrast, the use of an imidazolium salt, that is, an ionic liquid together with polyethylene oxide resulted in polymerization reaction to form a polymer thin film. [BMIM]TFSI did not participate in the polymerization reaction, which is assumedly due to the presence of TFSI that eliminates radicals participating in the polymerization reaction.

(2) Preparation of Plasma Polymer Thin Film According to the Varied Reaction Time

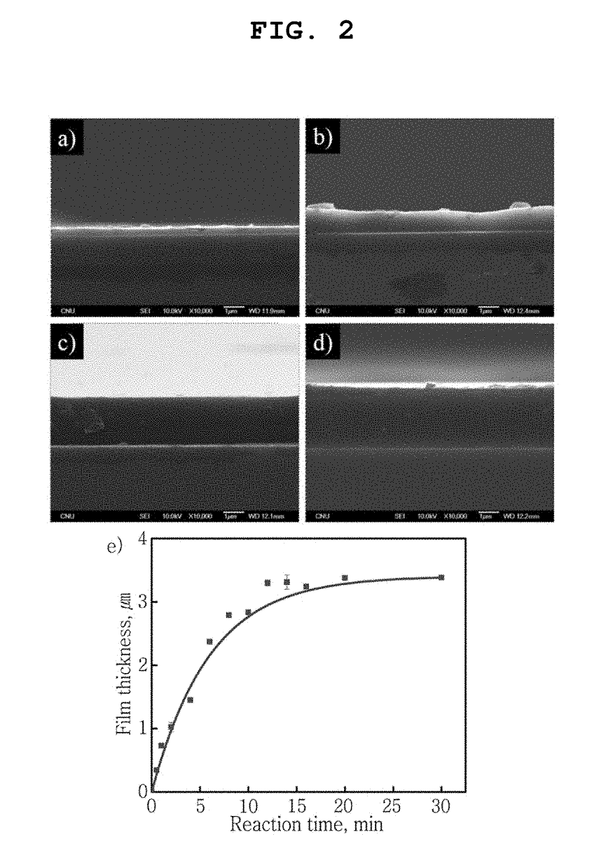

The procedures were performed in the same manner as described in the preparation method (1), excepting that the reaction time was controlled between 1 to 30 minutes. Triton X-100 and [BMIM]BF₄ were plasma-polymerized. The polymer thin film thus obtained was separated and its cross-section was observed with a scanning electron microscope (SEM, JEOL, JSM-7000F, USA). The observation results are presented in FIG. 2. Referring to FIG. 2, (a) to (d) show SEM images of the polymer thin film formed by the plasma polymerization reaction for 1, 2, 6, and 10 minutes, respectively; and (e) is a graph plotting the thickness of the thin film as a function of the reaction time.

As can be seen from the images and graph of FIG. 2, the thickness of the plasma polymer thin film increased in proportion to the reaction time in the early stage and then remained constant even with an increase in the reaction time once the spin-coated precursor was all polymerized with an elapse of the reaction time.

(3) Preparation of Plasma Polymer Thin Film According to the Different Ratios of Ionic Liquid to Polyethylene Oxide

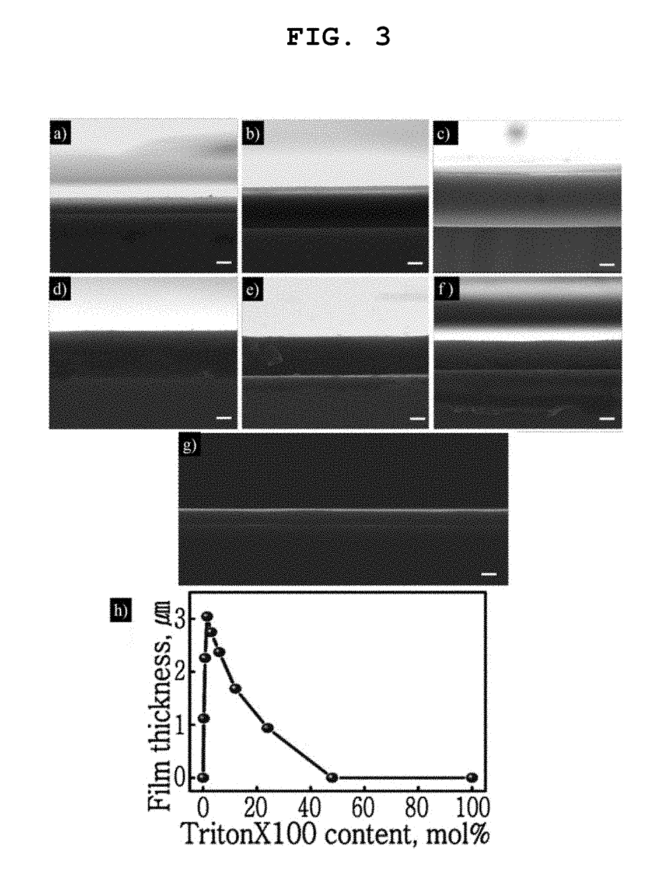

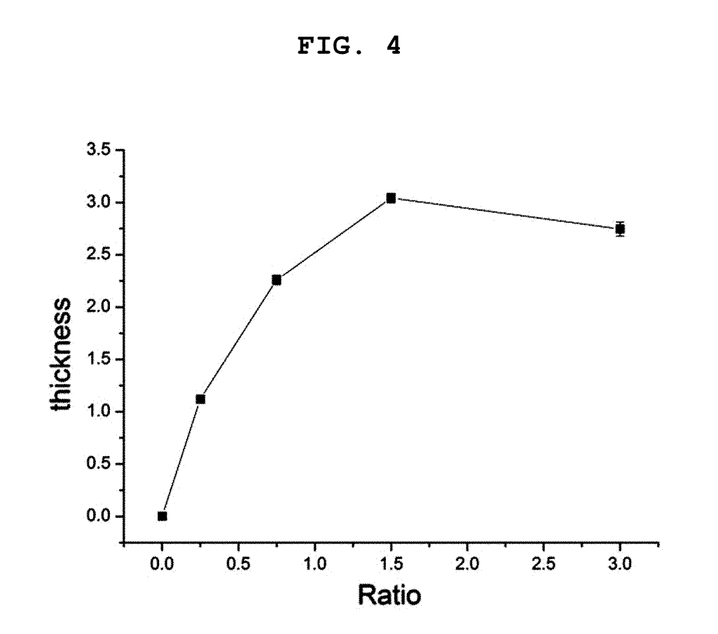

The procedures were performed in the same manner as described in the preparation method (1), excepting that the content (mol. %) of Triton X-100 was controlled between 0.3 to 48 mol. %. Triton X-100 and [BMIM]BF₄ were plasma-polymerized for 6 minutes (at air flow of 5 lpm). The polymer thin film thus obtained was separated and its cross-section was observed with a scanning electron microscope (SEM). The observation results are presented in FIG. 3. Referring to FIG. 3, (a) to (g) show SEM images of the cross-section of the polymer thin film formed by the 6-minute plasma polymerization reaction using 0.3, 0.7, 1.5, 3, 6, 12, and 24 mol. % of Triton X-100, respectively; and (h) is a graph plotting the thickness of the thin film as a function of the proportion of Triton X-100. As can be seen from FIG. 3, the molar ratio of the ionic liquid to polyethylene oxide affects the thickness of the thin film. FIG. 4 is a graph enlarging the interval where the content of Triton X-100 is 0 to 3 mol. %, revealing that the thickest film can be produced when the content of Triton X-100 is lowest as much as 1.5 mol. %.

### Example 2: Analysis of Structure of Plasma Polymer Thin Film

The plasma polymer thin film prepared in Example 1 was analyzed in regards to the structure with solid-NMR (Agilent 400 MHz, 54 mm, NMR DD2, USA), IR (Nicolet 670, USA) and XPS (Thermo Scientific MultiLab 2000) and to the thermal properties with a thermogravimeter (TGA/DSC1, Mettler-Toledo Inc.). In the following embodiment, the plasma polymers of Triton X-100 and [BMIM]BF₄ were used as species in the analysis. Unless otherwise stated, the species for the analysis are the polymers obtained from a 10-minute plasma polymerization reaction using 6 mol. % of Triton X-100 and [BMIM]BF₄ according to the preparation method described in section (1) of Example 1. The instruments used for the analysis are as follows.

(1) Structure Analysis Using Solid NMR and FT-IR

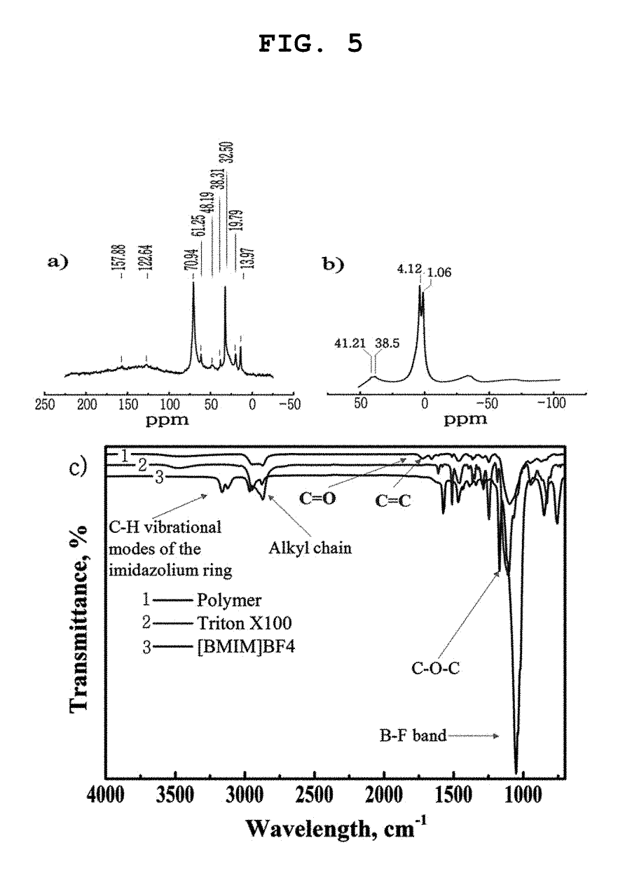

FIG. 5 shows (a)¹³C MAS-NMR, (b)¹H-MAS-NMR (at 15 kHz) and (c) FT-IR spectra of the polymer thin film. It can be seen from the IR spectrum that the C—H peak for the imidazolium ring of the plasma polymer is weak and that C═C and C═O bonds are formed.

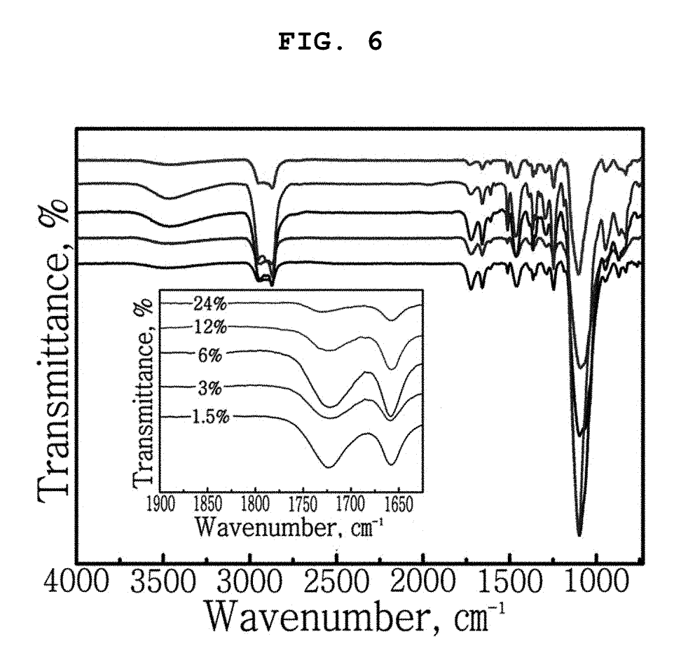

FIG. 6 is an IR spectrum of the polymer thin film as a function of the content (mol. %) of Triton X-100. In FIG. 6, the peak areas for C═O and C═C bonds are enlarged. Table 2 presents the relative intensity (I₁₆₆₀/I₁₇₂₅) of peaks representing C═C bond (1660 cm⁻¹) and C═O bond (1725 cm⁻¹) according to the content (mol. %) of Triton X-100.

TABLE 2

| Triton X-100 (mol. %) | I₁₆₆₀/I₁₇₂₅ |
|---|---|
| 1.5 | 0.92 |
| 3 | 1.06 |
| 6 | 1.15 |
| 12 | 1.88 |
| 24 | 1.86 |

As can be seen from FIG. 6 and Table 2, the proportion of the C═O bond relative to the C═C bond in the polymer decreases with an increase in the content of Triton X-100, and the red-shift of the C—O—C bond implicitly shows the presence of a double bond capable of being conjugated into the C—O—C bond.

(2) Structure Analysis Using X-Ray Photoelectron Spectroscopy (XPS)

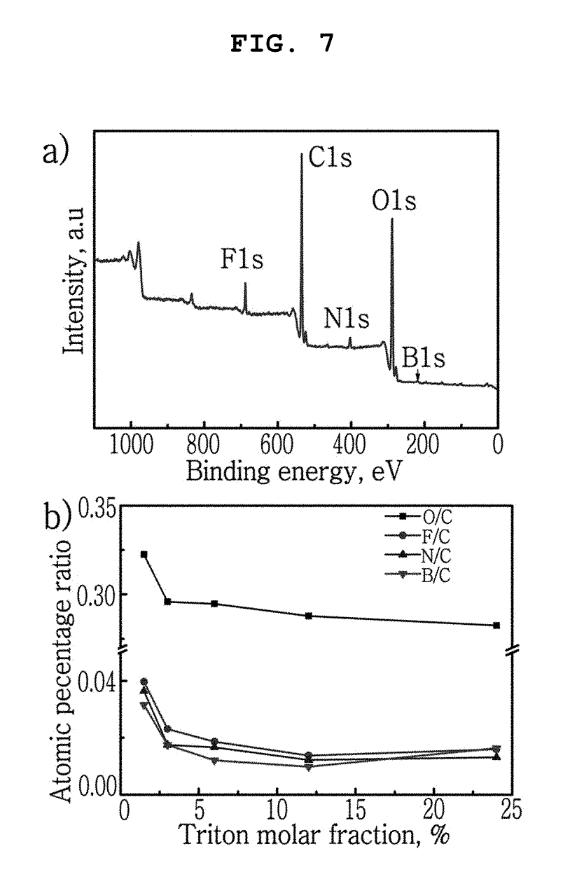

Referring to FIG. 7, (a) shows an XPS spectrum of the polymer thin film and (b) presents a graph plotting the ratio of elements in the polymer thin film as a function of the content (mol. %) of Triton X-100 as calculated from the XPS spectrum. The proportions (%) of the elements and their ratios in the plasma polymer according to the content (mol. %) of Triton X-100 are presented in Tables 3 and 4, respectively.

TABLE 3

| | Atomic percentage (%) | | | | |
|---|---|---|---|---|---|
| Triton X-100 (mol. %) | C | N | O | F | B |
| 1.5 | 69.91 | 2.55 | 22.55 | 2.78 | 2.21 |
| 3 | 73.18 | 1.28 | 21.65 | 1.69 | 1.28 |
| 6 | 74.51 | 1.24 | 21.96 | 1.39 | 0.90 |
| 12 | 75.56 | 0.92 | 21.75 | 1.04 | 0.74 |
| 24 | 75.30 | 0.99 | 21.27 | 1.20 | 1.23 |

TABLE 4

| Triton | Atomic percentage (%) | | | |
|---|---|---|---|---|
| X-100 (mol. %) | O/C | F/C | N/C | B/C |
| 1.5 | 0.322558 | 0.039765 | 0.036475 | 0.031612 |
| 3 | 0.295846 | 0.023094 | 0.017491 | 0.017491 |
| 6 | 0.294726 | 0.018655 | 0.016642 | 0.012079 |
| 12 | 0.287851 | 0.013764 | 0.012176 | 0.009794 |
| 24 | 0.282470 | 0.015936 | 0.013147 | 0.016335 |

It can be seen that as the content of [BMIM]BF₄ decreases relatively with an increase in the content of Triton X-100, the contents of F, N and B in the polymer decrease, where F, N and B are contained only in [BMIM]BF₄. Further, the reduction of the O/C ratio with an increase in the content of Triton X-100 assumedly has a close relation with the C═C/C═O bond ratio in FIG. 6 and Table 2. Namely, the cross-linking between Triton X-100 and Triton X-100 rather than between the ionic liquid and Triton X-100 increases with an increase in the content of Triton X-100, so it can be assumed that the oxygen atoms are eliminated in the form of CO or CO₂ during the cross-linking process to reduce the O/C ratio.

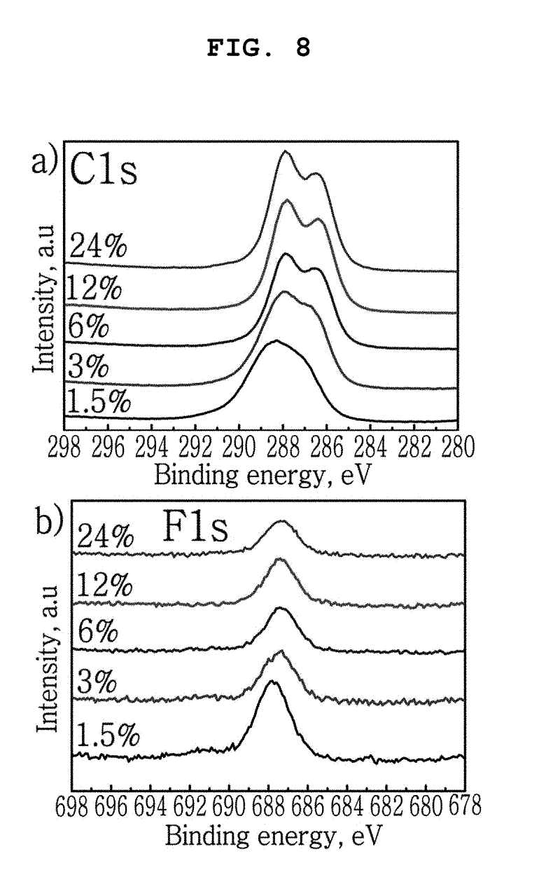

Referring to FIG. 8, (a) and (b) show the spectra enlarging the peaks corresponding to the is electrons of C and F as a function of the content (mol. %) of Triton X-100, respectively.

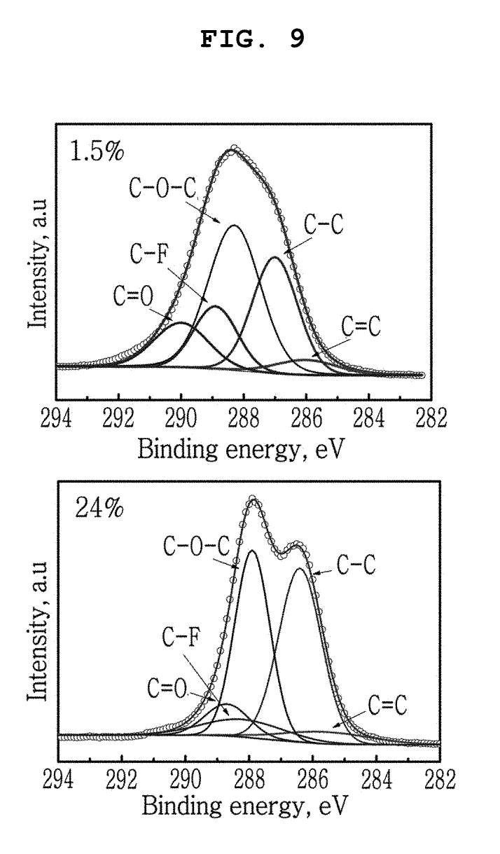

The peak for the is electron of C shifts to the lower energy according to the content of Triton X-100. Hence, the composition of the C1s peak of the plasma polymer prepared using 1.5 mol. % or 24 mol. % of Triton X-100 is analyzed in consideration of the types of the bonds forming the polymer (Plasmas and Polymers, Vol. 7, No. 4, p311-325, December 2002). FIG. 9 shows a spectrum presenting the simulation results of peaks. The proportions of the peaks are presented in Table 5. It can be seen from the analytical results that the C═O and C—F bonds greatly decreases and the proportion of the C—C bond increases with an increase in the content of Triton X-100. In addition, the ratio of C═C/C═O is almost doubled and becomes in agreement with the results obtained from the ratio of peak intensities from the IR spectrum.

TABLE 5

| Triton | | | | | | |
|---|---|---|---|---|---|---|
| X-100 | % | | | | | |
| (mol. %) | C═C | C—C | C—O—C | C═O | C—F | C═C/C═O |
| 1.5 | 5.07 | 27.48 | 40.67 | 14.02 | 12.76 | 0.36 |
| | (286 eV) | (286.7 eV) | (288.2 eV) | (288.9 eV) | (290 EV) | |
| 24 | 5.08 | 41.44 | 36.88 | 8.08 | 7.82 | 0.72 |
| | (285.6 eV) | (286.4 eV) | (287.9 eV) | (288.2 eV) | (288.7 eV) | |

(3) Thermal Analysis

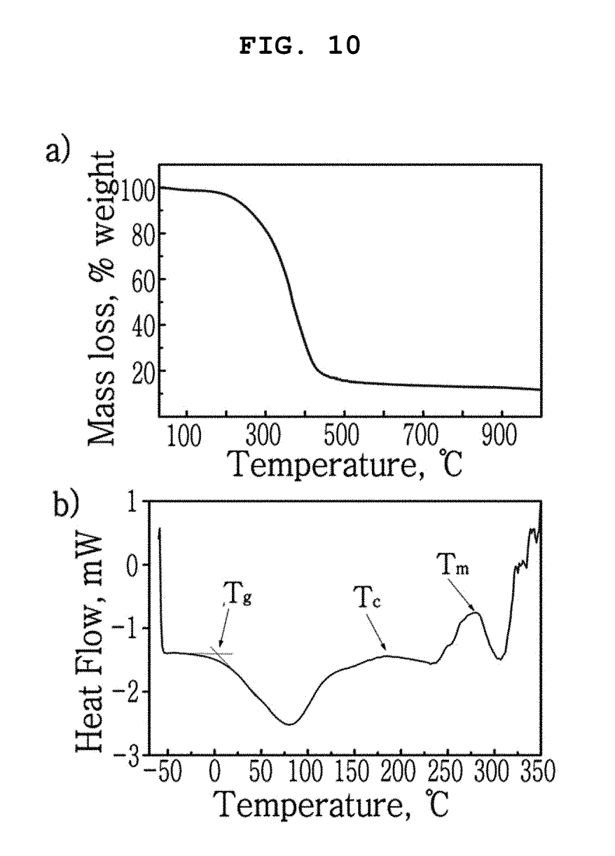

The polymer thin film obtained from the plasma polymerization was analyzed with a thermogravimeter. FIG. 10 presents DSC and TGA spectra of the polymer thin film heated from 25° C. up to 1,000° C. at a rate of 10° C./min, showing that the polymer has such a high thermal stability as to display a degradation temperature of 200° C. or above. Further, the Tg and Tm values measured from the DSC spectrum were 3.11° C. and 279.50° C., respectively.

The conventional gel polymer electrolytes display poor durability at high temperature, as they have such a low Tm value as much as 40 to 50° C. for PEO and 160° C. for PVDF or PMMA. But the plasma polymer of the present invention has a Tm value as high as about 300° C., so the driving temperature of the equipment using it increases relative to that of equipment using the conventional gel polymer electrolyte.

### Example 3: Analysis on Electrical Properties of Plasma Polymer Thin Film

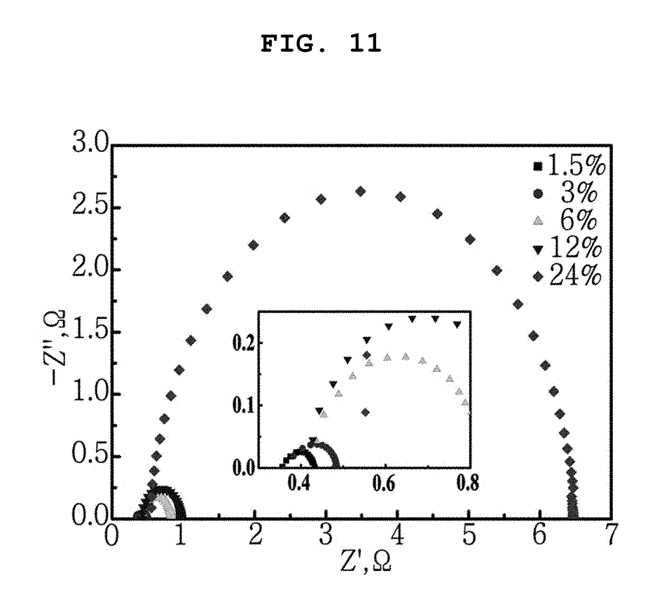

The plasma thin film prepared in Example 1 was inserted into a nickel-ion battery to complete a thin film type cell, in order to measure its electrical properties. 0.5 ml of 1M LiPF6/DMC as an electrolyte was added, and the tightly sealed specimen was stabilized at 150° C. for 3 seconds before use. With the cell connected to a potentiostat (IVIUMSTAT, Ivium Technologies) using a lead wire, the resistance value of the specimen was measured according to the alternating current impedance method. FIG. 11 is a graph plotting the impedance measurements. The ion conductivity (·ò) was determined from the resistance value (R_{b}) and thickness ( [symbol] ,) of the specimen calculated from the graph and the area (A) of the polymer electrolyte according to the following equation. The results are presented in Table 12.

$$σ = \frac{l}{{R}_{b} A}$$

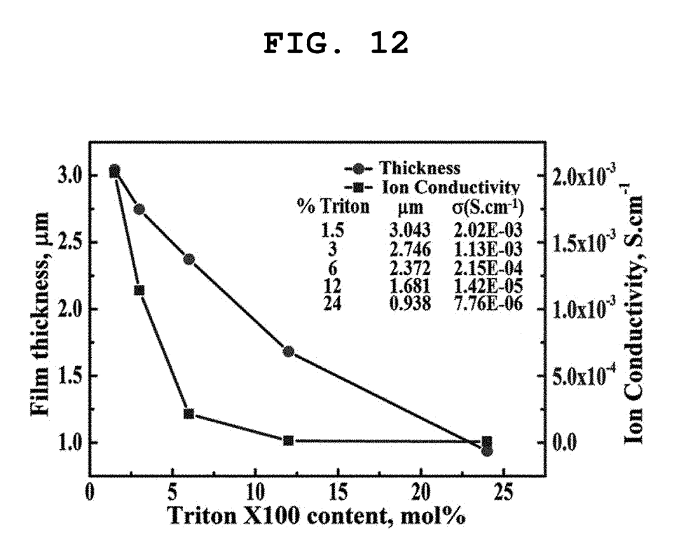

FIG. 12 shows that the electrical conductivity decreases with an increase in the content of Triton X-100. This is in good agreement with the predictions induced from the analytical results of the IR and XPS spectra that the C═C/C═O ratio increases with an increase in the content of Triton X-100 and those of the XPS spectrum that the proportion of polar bonds such as C═O or C—F reduces with an increase in the content of Triton X-100. In addition, the ion conductivity was so high as 10⁴ or greater when the content of Triton X-100 was 6% or below.

What is claimed is:

1. A method for preparing a polymer thin film, the method comprising:
applying plasma to an interface of a liquid-state monomer to perform polymerization.

2. The method as claimed in claim 1, further comprising:
applying the liquid-state monomer on a substrate before the step of applying plasma; and
exfoliating a plasma-polymerized polymer from the substrate after the step of applying plasma.

3. The method as claimed in claim 1, wherein the liquid-state monomer is a mixture of ionic liquid and polyethylene oxide.

4. The method as claimed in claim 3, wherein the ionic liquid is a salt comprising a cation being a substituted or unsubstituted 1-R-1-methylpyrrolidium or a substituted or unsubstituted 1-R-3-methylimidazolium, wherein R is C₃-C₁₆ alkyl, and an anion being BF₄⁻, F⁻, Cl⁻, Br⁻, or I⁻.

5. The method as claimed in claim 3, wherein the polyethylene oxide has a molecular weight of 200 to 2,000.

6. The method as claimed in claim 3, wherein the polyethylene oxide is 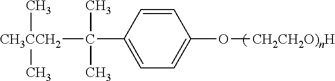
or Tween 80,
wherein n=5˜30.

7. The method as claimed in claim 6, wherein the content of the polyethylene oxide is 25 mol % or lower.

8. The method as claimed in claim 2, wherein the liquid-state monomer is a mixture of ionic liquid and polyethylene oxide.

9. The method as claimed in claim 8, wherein the ionic liquid is a salt comprising a cation being a substituted or unsubstituted 1-R-1-methylpyrrolidium or a substituted or unsubstituted 1-R-3-methylimidazolium, wherein R is C₃-C₁₆ alkyl, and an anion being BF₄⁻, F⁻, Cl⁻, Br⁻, or I⁻.

10. The method as claimed in claim 8, wherein the polyethylene oxide has a molecular weight of 200 to 2,000.

11. The method as claimed in claim 8, wherein the polyethylene oxide is 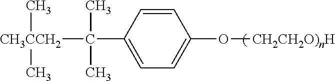
or Tween 80,
wherein n=5˜30.

12. The method as claimed in claim 11, wherein the content of the polyethylene oxide is 25 mol % or lower.

13. A plasma polymer thin film prepared by the method as claimed in claim 1.

14. A polymer matrix for a gel polymer electrolyte comprising the plasma polymer thin film as claimed in claim 13.

15. A gel polymer electrolyte comprising an organic electrolyte containing an ionic salt, the organic electrolyte being impregnated into the plasma polymer as claimed in claim 13.

16. A secondary cell comprising the gel polymer electrolyte as claimed in claim 15.

17. A plasma polymer thin film prepared by the method as claimed in claim 2.

18. A polymer matrix for a gel polymer electrolyte comprising the plasma polymer thin film as claimed in claim 17.

19. A gel polymer electrolyte comprising an organic electrolyte containing an ionic salt, the organic electrolyte being impregnated into the plasma polymer as claimed in claim 17.

20. A secondary cell comprising the gel polymer electrolyte as claimed in claim 19.
